(19) United States
(12) Patent Application Publication
(10) Pub. No.: US 2025/0338052 A1
(43) Pub. Date: Oct. 30, 2025

(54) MICROPHONE APPARATUS

(71) Applicant: CANON KABUSHIKI KAISHA, Tokyo (JP)

(72) Inventors: KEIICHIRO SAITO, Tokyo (JP); Yuusuke Sasaki, Tokyo (JP)

(21) Appl. No.: 19/074,947

(22) Filed: Mar. 10, 2025

(30) Foreign Application Priority Data
Apr. 25, 2024 (JP) 2024-071631

(51) Int. Cl. H04R 1/08; H04R 1/02

(52) U.S. Cl. CPC H04R 1/08; H04R 1/02

(57) ABSTRACT

A microphone apparatus includes a microphone element, a wiring, a first member, a second member, a holder, and a housing. The microphone element, the wiring, the first member, the second member, and the holder are disposed inside the housing. The holder holds at least one of the first member and the second member. The wiring electrically connects the microphone element to at least one of the first member and the second member. At least a part of the wiring is housed in space formed by the holder, the first member, and the second member.

### BACKGROUND

### Technical Field

The disclosure relates to a microphone apparatus.

### Description of Related Art

One conventional imaging method uses a wireless microphone (microphone apparatus) that transmits and receives audio signals via wireless communication. Japanese Patent Application Laid-Open No. 2011-120170 discloses a microphone apparatus in which a MEMS capacitor and a detection circuit are disposed on non-adjacent sides inside a housing, and a flexible printed circuit (FPC) is curved to electrically connect the MEMS capacitor and the detection circuit.

In the configuration disclosed in Japanese Patent Application Laid-Open No. 2011-120170, noises such as vibrations caused by the user's motions or creaking sounds generated when force are applied to the housing of the microphone apparatus propagate through the wiring, and thus may be recorded.

### SUMMARY

A microphone apparatus according to one aspect of the disclosure includes a microphone element, a wiring, a first member, a second member, a holder, and a housing. The microphone element, the wiring, the first member, the second member, and the holder are disposed inside the housing. The holder holds at least one of the first member and the second member. The wiring electrically connects the microphone element to at least one of the first member and the second member. At least a part of the wiring is housed in space formed by the holder, the first member, and the second member.

A microphone apparatus according to another aspect of the disclosure includes a microphone element, a wiring, and a housing. The housing includes a first housing and a second housing disposed inside the first housing. The wiring electrically connects the microphone element and the second housing. At least a part of the wiring is housed in space formed by the second housing.

Further features of various embodiments of the disclosure will become apparent from the following description of embodiments with reference to the attached drawings.

### BRIEF DESCRIPTION OF THE DRAWINGS

FIG. 1 is a schematic diagram of a microphone apparatus according to each example.

FIG. 2 is a sectional view of the microphone apparatus according to Example 1.

FIGS. 3A and 3B are structural views of a microphone apparatus according to Example 2.

FIGS. 4A and 4B are structural views of a microphone apparatus according to Example 3.

FIG. 5 is a sectional view of a microphone apparatus according to Example 4.

FIGS. 6A, 6B, 6C, and 6D are structural views of a microphone apparatus according to Example 5.

FIG. 7 is a sectional view of a microphone apparatus according to Example

6.

FIG. 8 is a sectional view of a microphone apparatus according to Example 7.

FIGS. 9A, 9B, and 9C are structural views of a microphone apparatus according to Example 8.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

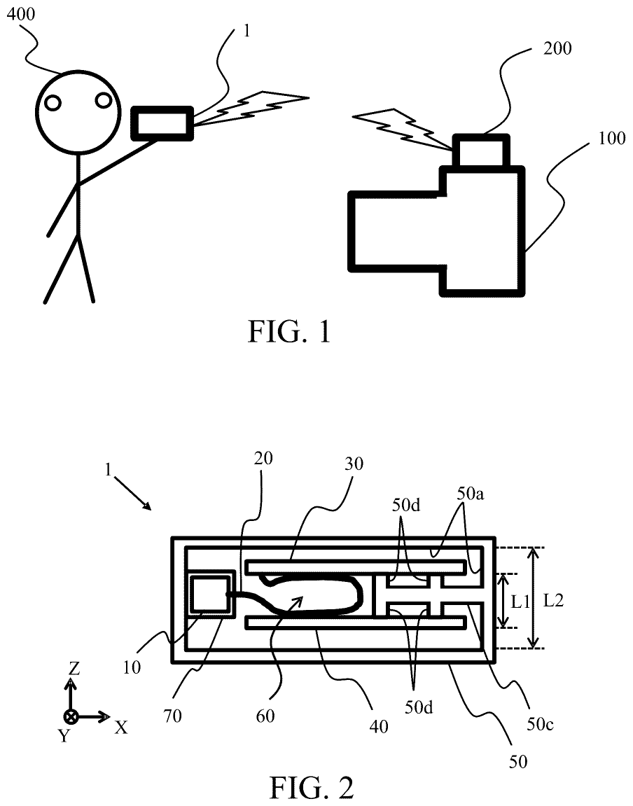

Referring now to FIG. 1, a description will be given of an overview of a microphone apparatus 1 according to each example. FIG. 1 is a schematic diagram of the microphone apparatus 1 (2 to 7). The microphone apparatus 1 is wirelessly connected to a communication unit 200 mounted on the image pickup apparatus 100, and transmits audio data such as the voice of a user 400 and surrounding sounds to the communication unit 200 by wireless communication. The communication unit 200 is electrically connected to an image pickup apparatus 100, and transmits audio data received from the microphone apparatus 1 to the image pickup apparatus 100. The image pickup apparatus 100 stores the audio data received from the communication unit 200 in a storage medium provided in it. Thereby, audio data acquired from the microphone apparatus 1 can be stored in the image pickup apparatus 100.

The microphone apparatus 1 is intended to be used by the user 400 by holding it in his hand or by wearing it on his clothing using a holder such as a clip, and a microphone element 10 and a substrate, which will be described later, are housed inside the housing 50 of the microphone apparatus 1.

Each example will be described in detail below.

### Example 1

Referring now to FIG. 2, a description will be given of the microphone apparatus 1 according to Example 1. FIG. 2 is a sectional view of the microphone apparatus 1 according to this example. As illustrated in FIG. 2, the microphone apparatus 1 includes the microphone element 10, a wiring 20, a first member 30, a second member 40, and the housing 50. The microphone element 10, the wiring 20, the first member 30, and the second member 40 are housed inside the housing 50.

The microphone element 10 is covered by a first damper 70, which will be described later, and is held in the housing 50 via the first damper 70. The first damper 70 is an elastic member such as natural rubber, silicone rubber, or sponge. The housing 50 has an outer shape of a substantially rectangular parallelepiped. A holder (holding member) 50c having a rib-shaped internal shape extending in a center direction of the housing 50 (−X-axis direction in FIG. 2) is provided substantially vertically on the inner side surface 50a of the housing 50. That is, the holder 50c is a rib extending substantially perpendicularly from the inner side surface 50a of the housing 50. The holder 50c is provided with a connector 50d protruding in the Z-axis direction. The first member 30 and the second member 40 are fixed to the connector 50d by screw members (not illustrated), and their positions relative to the housing 50 are determined.

Each of the first member 30 and the second member 40 includes an electronic substrate having an approximately plate shape. At least one of the first member 30 and the second member 40 is electrically connected to the wiring 20 described below. The main surface of the first member 30 and the main surface of the second member 40 are held by the holder 50c so as to be substantially perpendicular to the thickness direction (Z-axis direction) of the housing 50. Thereby, the first member 30 and the second member 40 are disposed so as to be approximately parallel to each other at positions separated from each other in the Z-axis direction due to a difference in the height direction of the connector 50d. This difference in the height direction forms space 60 between the first member 30 and the second member 40. The microphone element 10 and the wiring 20 are electrically connected.

One end of the wiring 20 is connected to the microphone element 10 by penetrating a part of the first damper 70 that covers the microphone element 10. The other end of the wiring 20 (the end opposite to the end connected to the microphone element 10) is electrically connected to either the first member 30 or the second member 40. A part of the wiring 20 is housed in a bent state inside the space 60 formed between the first member 30 and the second member 40. The wiring 20 contacts each of the first member 30 and the second member 40 due to a repulsive force generated when the wiring 20 is bent. Thus, the microphone apparatus 1 is configured so that the wiring 20 does not directly contact the housing 50.

Next, the propagations of noises in the cases where the wiring 20 is in contact with the housing 50 and where it is not in contact with the wiring 20 will be described together with the usage situation of the microphone apparatus 1.

The microphone element 10 converts the collected sound into an electric signal and sends the signal via the wiring 20 to an electronic substrate, which is either the first member 30 or the second member 40. The electronic substrate converts the electric signal sent from the microphone element 10 into audio data and stores the data in a storage medium inside the electronic substrate or transmits the audio data to the communication unit 200.

In a case where the user 400 attempts to operate the microphone apparatus 1 during recording of audio data, the user 400 touches an unillustrated operation unit provided on the outermost surface of the microphone apparatus 1. At this time, the user 400 touches or grips the housing 50 of the microphone apparatus 1, so that force such as an impact propagation or deformation is applied to the microphone apparatus 1. The action of the user 400 walking, running, jumping, etc. during recording of audio data may be transmitted to the microphone apparatus 1 as vibrations.

If the wiring 20 contacts the inner side surface 50a of the housing 50, the touch noise generated when the user 400 touches the housing 50 or the vibrations generated by the action is directly transmitted to the wiring 20. If the shape of the housing 50 is deformed by the user 400 gripping the housing 50, the contact state of the wiring 20 in contact with the inner side surface 50a of the housing 50 may change, and the noises may be recorded as a rubbing sound. Thus, if the wiring 20 directly contacts the inner side surface 50a of the housing 50, the disturbance caused by the user 400's operation may be recorded as noises such as mechanical noises.

On the other hand, in the microphone apparatus 1 according to this example, the wiring 20 is not in direct contact with the inner side surface 50a of the housing 50. Thereby, the propagation path from the housing 50 to the wiring 20 increases, and noises can be reduced. In addition, the wiring 20 and the parts in contact with the wiring 20 (the first member 30 and the second member 40) are away from the inner side surface 50a of the housing 50 (not in contact with the inner side surface 50a), the propagation of force can be suppressed.

A description will now be given of other operations of the microphone apparatus 1 according to this example. In the microphone apparatus 1, the position in the height direction of each of the first member 30 and the second member 40 is determined by the height (length in the Z-axis direction) of the connector 50d provided on the holder 50c. Thereby, even if the user 400 applies force in the Z-axis direction by gripping the housing 50, the force does not propagate beyond the holder 50c, so the relative positions of the first member 30 and the second member 40 in the height direction do not change. Maintaining a relative positional relationship among the first member 30 and the second member 40 and the wiring 20, each contact state does not change, so noise such as rubbing noise or creaking noise can be reduced.

In the microphone apparatus 1, the space 60 is part of the internal space of the housing 50 that includes the approximate center of the housing 50 in the thickness direction (Z-axis direction). The approximate center of the housing 50 in the thickness direction is a position physically separated from the outermost surface of the housing 50, and the wiring 20 and the intervening parts that hold the wiring 20 are disposed based on this position. These intervening parts increase the force transmission path from the outermost surface of the housing 50 to the wiring 20, and thus reduce the stress applied to the wiring 20. Length L1 of the space 60 in the thickness direction of the housing 50 is 75% or less or of 50% or less of length L2 of the internal space of the housing 50.

In the microphone apparatus 1, the microphone element 10 is covered with the first damper 70 and is held by the housing 50 via the first damper 70. Since the microphone element 10 is covered with the first damper 70, vibrations or impacts transmitted from the exterior surface of the housing 50 to the microphone element 10 and the wiring 20 can be suppressed.

In the microphone apparatus 1, at least one of the first member 30 and the second member 40 is made of a material having a higher rigidity than the rigidity of the housing 50. Using a material of at least one of the first member 30 and the second member 40 having a higher rigidity than the housing 50 can increase the rigidity toward the inside of the microphone apparatus 1. Thereby, even if the user 400 applies a strong force to the microphone apparatus 1, the force caused by the deformation of the housing 50 can be received by the first member 30 or the second member 40, so that the force applied to the wiring 20 can be suppressed. Thus, by increasing the strength of the first member 30 or the second member 40, the deformation of the housing 50 can be suppressed, and abnormal sounds (noises) such as rubbing or creaking of the wiring 20 can be reduced.

### Example 2

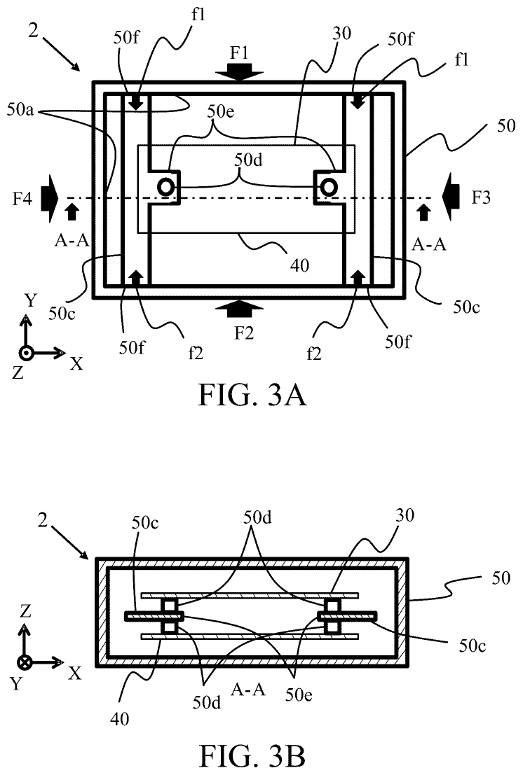

Referring now to FIGS. 3A and 3B, a description will be given of a microphone apparatus 2 according to Example 2. FIGS. 3A and 3B are structural views of the microphone apparatus 2 according to this example. FIG. 3A is a view viewed from a direction in which the first member 30 and the second member 40 are flat (Z-axis direction), and FIG. 3B is a sectional view of an A-A section in FIG. 3A viewed in the +Y-axis direction. FIGS. 3A and 3B illustrate details of the holder 50c that suppresses the propagation of force to the first member 30 and the second member 40. The holder 50c is provided so that a distance from the inner side surface 50a of the housing 50 to the connector 50d is long. That is, the connector (first connector) 50d is provided in an area of the holder 50c that is farthest from a connector (second connector) 50f with the inner side surface 50a of the housing 50. For a simple description, the microphone element 10 and the wiring 20 are omitted in FIGS. 3A and 3B.

The two holders 50c extend along the Y-axis direction relative to the housing 50. The two holders 50c are approximately parallel to each other, and each of the two holders 50c has a bridge shape extending so that both ends are connected to the inner side surface 50a of the housing 50. As illustrated in FIG. 3B, the connector 50d is provided on the holder 50c to hold the first member 30 and the second member 40 arranged in the +Z-axis direction relative to the holder 50c. The first member 30 and the second member 40 are fixed to the connector 50d by fixing members such as screws, and the positions of the first member 30 and the second member 40 in the thickness direction (Z-axis direction) are determined relatively.

A description will now be given of the action when force is applied to the microphone apparatus 2. FIG. 3A illustrates a state in which force is applied in the Y-axis direction as forces F1 and F2 when the user 400 grips the microphone apparatus 2. Forces F1 and F2 are generated when the user 400 grips the housing 50, and forces F1 and F2 are balanced. Forces F1 and F2 are distributed and propagated to the two holders 50c as forces f1 and f2, respectively. Forces f1 and f2 are balanced on the holder 50c, and the holder 50c is in a state where the stress is applied due to the balance of forces f1 and f2.

In this example, a convex portion 50e that protrudes in the X-axis direction is provided at a midpoint of the holder 50c, and a connector 50d is disposed on the convex portion 50e. The convex portion 50e of the holder 50c is farther away from the inner side surface 50a of the housing 50 than other parts of the holder 50c. Hence, a distance over which the stress propagates to the connector 50d is longer than other parts of the holder 50c. This increased distance over which the stress propagates can disperse the stress on the holder 50c and suppress the force applied to the connector 50d and the first member 30 and the second member 40 fixed to the connector 50d.

On the other hand, in a case where the convex portion 50e is disposed close to the inner side surface 50a of the housing 50, the distance over which the stress propagates is reduced, and the stress cannot be sufficiently dispersed by the holder 50c. In a case where the stress cannot be sufficiently dispersed, forces f1 and f2 are transmitted more strongly, and the stronger force is applied to the connector 50d and the first member 30 and the second member 40 fixed to the connector 50d.

Thus, dispersing the stress by increasing the distance from the inner side surface 50a of the housing 50 to the connector 50d can suppress the force transmitted to the first member 30 and the second member 40.

A description will now be given of a state in which forces are applied in the X-axis direction, such as forces F3 and F4 illustrated in FIG. 3A. The directions of forces F3 and F4 are perpendicular (X-axis direction) to the direction in which the holder 50c extends (Y-axis direction). An area near the inner side surface 50a of the housing 50, where forces F3 and F4 are generated, and the convex portion 50e are spaced apart from each other (by a distance in the Y-axis direction). Therefore, the stress generated by forces F3 and F4 is transmitted along the side surface of the housing 50, detouring through the holder 50c. Thus, the propagation distance of forces F3 and F4 is longer than the propagation distance of forces F1 and F2, so that the propagation of the stress can be further suppressed.

By providing the connector 50d at a position away from the inner side surface 50a of the housing 50 on the holder 50c, this embodiment suppresses the force applied to each of the first member 30 and the second member 40. As a result, the abnormal sound (noise) generated by the application of force to the wiring 20 can be reduced.

### Example 3

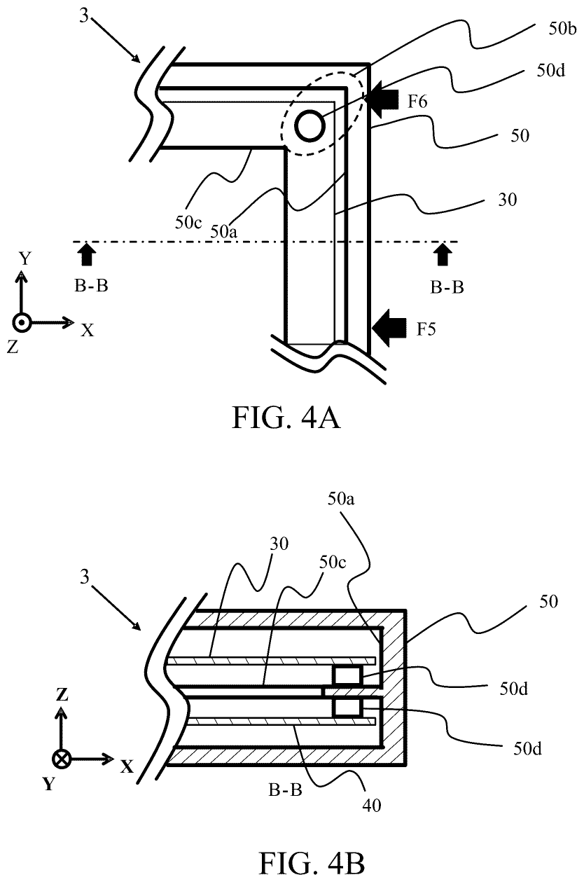

Referring now to FIGS. 4A and 4B, a description will be given of a microphone apparatus 3. FIGS. 4A and 4B are structural views of the microphone apparatus 3 according to this example, and illustrate details of the holder 50c that suppresses the transmission of force to the first member 30 and the second member 40. The holder 50c extends in an approximately L-shape to the corner 50b of the inner side surface 50a of the housing 50, and the connector 50d is provided in the area near the corner 50b. FIG. 4A is a view viewed from a direction in which each of the first member 30 and the second member 40 is flat (Z-axis direction), and FIG. 4B is a sectional view of a B-B section in FIG. 4A viewed in the +Y-axis direction.

The holder 50c extends relative to the inner side surface 50a of the housing 50. The holder 50c has an approximately L-shape so as to fit along a corner 50b of the housing 50. As illustrated in FIG. 4B, the connector 50d is provided near the corner 50b of the housing 50 to hold the first member 30 and the second member 40 in the Z-axis direction. The first member 30 and the second member 40 are fixed to the connector 50d by fixing members such as screws, and the positions of the first member 30 and the second member 40 in the thickness direction (Z-axis direction) are determined relative to each other.

A description will be given of the effect of providing the connector 50d near the corner 50b of the housing 50. The holder 50c illustrated in FIG. 4A has a rib shape for reinforcing the housing 50 to suppress bending and deformation when the user 400 grips the side of the housing 50. Force F5 indicates force when the user 400 grips the housing 50 at a position away from the corner 50b of the housing 50. Force F6 indicates force when the user 400 grips the housing 50 in the area near the corner 50b of the housing 50. In a case where forces F5 and F6 are equivalent forces, when the force F5 is applied from outside the housing 50, the side of the housing 50 bends and deforms with the corner 50b as the fulcrum. Due to the deformation of the side of the housing 50, the connector 50d and the first member 30 and the second member 40 connected to the connector 50d receive force F5. As a result, a strong force is applied to the first member 30 and the second member 40.

A deformation amount of the side of the housing 50 is suppressed as a position where the force is applied approaches the area near the corner 50b, which serves as the fulcrum, i.e., the position of force F6. Providing the connector 50d as the holder at a position where the deformation amount is small when the force is applied (which may be a position where the deformation amount is minimum), i.e., a high rigidity area can suppress the deformation of the first member 30 and the second member 40. As a result, the force applied to the wiring 20 can be suppressed.

### Example 4

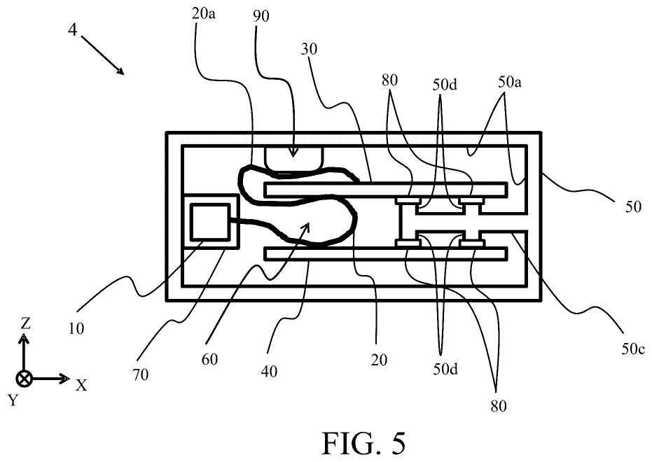

Referring now to FIG. 5, a description will be given of a microphone apparatus 4 according to Example 4. FIG. 5 is a sectional view of the microphone apparatus 4 according to this example. As illustrated in FIG. 5, the microphone apparatus 4 has the microphone element 10, the wiring 20, the first member 30, the second member 40, and the housing 50. The microphone element 10, the wiring 20, the first member 30, and the second member 40 are housed inside the housing 50.

The microphone element 10 is covered with the first damper 70 and is held in the housing 50 via the first damper 70. The first damper 70 is an elastic member such as natural rubber, silicone rubber, or sponge. The housing 50 has an outer shape of a substantially rectangular parallelepiped. The holder 50c has a rib-like internal shape extending toward the center of the housing 50 (the −X-axis direction in FIG. 5) and is provided substantially vertically on the inner side surface 50a of the housing 50. The holder 50c includes the connector 50d protruding in the Z-axis direction.

A second damper 80 is provided at the tip of the connector 50d. The second damper 80 is an elastic member such as natural rubber, silicon rubber, or sponge. The first member 30 and the second member 40 are fixed to the connector 50d via the second damper 80 by fixing members such as screws, anti-pullout pins, or light press-fitting with holes and shafts (not illustrated), and are positioned relative to the housing 50.

Each of the first member 30 and the second member 40 includes an electronic substrate having an approximately plate shape. At least one of the first member 30 and the second member 40 is electrically connected to the wiring 20. The first member 30 and the second member 40 are arranged so as to be approximately parallel at positions separated in the Z-axis direction by the difference in the height direction of the connector 50d of the rib-shaped holder 50c. In other words, the holder 50c holds the first member 30 and the second member 40 so as to be perpendicular to the thickness direction (Z-axis direction) of the housing 50, and thereby the positions of the first member 30 and the second member 40 are determined in the Z-axis direction. Due to this difference in height, a space 60 is formed between the first member 30 and the second member 40. The microphone element 10 and the wiring 20 are electrically connected.

One end of the wiring 20 is connected to the microphone element 10 by penetrating a part of the first damper 70 covering the microphone element 10. The other end of the wiring 20 (the end opposite to the end connected to the microphone element 10) is electrically connected to either the first member 30 or the second member 40. A part of the wiring 20 is housed in a bent state inside the space 60 formed between the first member 30 and the second member 40. The wiring 20 contacts each of the first member 30 and the second member 40 due to a repulsive force generated when the wiring 20 is bent.

When the area of the wiring 20 adjacent to (near) the inner side surface 50a of the housing 50 is set to the wiring portion 20a, a third damper 90 is provided between the wiring portion 20a and the inner side surface 50a of the housing 50. The third damper 90 is an elastic member such as natural rubber, silicone rubber, or sponge. One surface (first surface) of the third damper 90 is fixed to the inner side surface 50a of the housing 50 with an adhesive member such as tape or adhesive, and the other surface (second surface opposite to the first surface) contacts the wiring portion 20a.

In this example, a member that is in mechanical contact with the housing 50 or a member that may come into contact depending on the assembly variation is held or biased via the damper. Vibrations or impacts transmitted from the housing 50 to the first member 30 and the second member 40, or the wiring 20, can be suppressed by using the damper. Thereby, abnormal sounds (noises) caused by vibrations or impacts that occur when the user 400 wears and uses the microphone apparatus 4 can be suppressed.

### Example 5

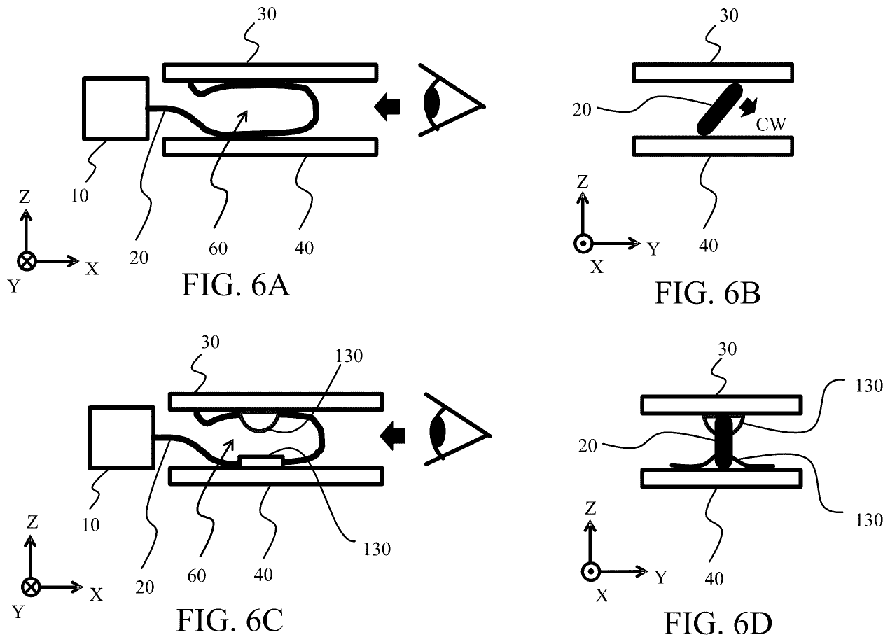

Referring now to FIGS. 6A, 6B, 6C, and 6D, a microphone apparatus according to Example 5 will be described. This example is a variation of the microphone apparatuses 1 to 4 according to Examples 1 to 4. FIGS. 6A, 6B, 6C, and 6D illustrate extracted internal parts of the microphone apparatuses 1 to 4 described in Examples 1 to 4, and a state in which the microphone element 10, the wiring 20, the first member 30, and the second member 40 are held by a housing 50 (not illustrated). FIGS. 6A and 6B illustrate the fall of the wiring 20, and FIGS. 6C and 6D explain how to prevent the fall.

In FIG. 6A, the wiring 20 is housed in the space 60 formed between the first member 30 and the second member 40 with a part of the wiring 20 bent. The wiring 20 is biased against the first member 30 and the second member 40 by the elastic force generated when the wiring 20 is bent. This biasing force causes the wiring 20 to contact the first member 30 and the second member 40. In this state, if there is assembly variation or if the microphone apparatuses 1 to 4 are subjected to vibration or impact, the orientation of the wiring 20 may not be stably held and may fall over as illustrated in FIG. 6B. FIG. 6B illustrates FIG. 6A as viewed in the −X-axis direction, and illustrates the folded portion of the wiring 20 as viewed from one end.

In FIG. 6B, the wiring 20 is biased against each of the first member 30 and the second member 40 by the elastic force of the wiring 20 while the wiring 20 has fallen in an arrow cw direction. Due to the biasing force at this time, the bending diameter of the wiring 20 is larger than the diameter under the biasing force before the wiring 20 falls over. Therefore, the biasing force decreases in proportion to the decrease in the elastic force of the wiring 20. The wiring 20 may further fall due to vibrations or impacts. Due to the fall of the wiring 20, the desired elastic force cannot be applied to each of the first member 30 and the second member 40. As a result, the orientation of the wiring 20 becomes unstable and suspended in the space 60. If vibration or impact is applied to the wiring 20 while it is suspended in the air, the wiring 20 may repeatedly collide with other members and become a source of noise.

FIG. 6C illustrates the orientation maintained by a fixing member 130 such as an adhesive or tape to prevent the wiring 20 from falling as described with reference to FIG. 6A. FIG. 6D illustrates the state of FIG. 6C when viewed in the −X-axis direction. Holding at least one of the contact position between the wiring 20 and the first member 30 and the contact position between the wiring 20 and the second member 40 with the fixing member 130 can suppress the wiring 20 from falling due to vibration or impact. Thereby, abnormal sounds (noises) that occur when the wiring 20 collides with other members can be suppressed.

### Example 6

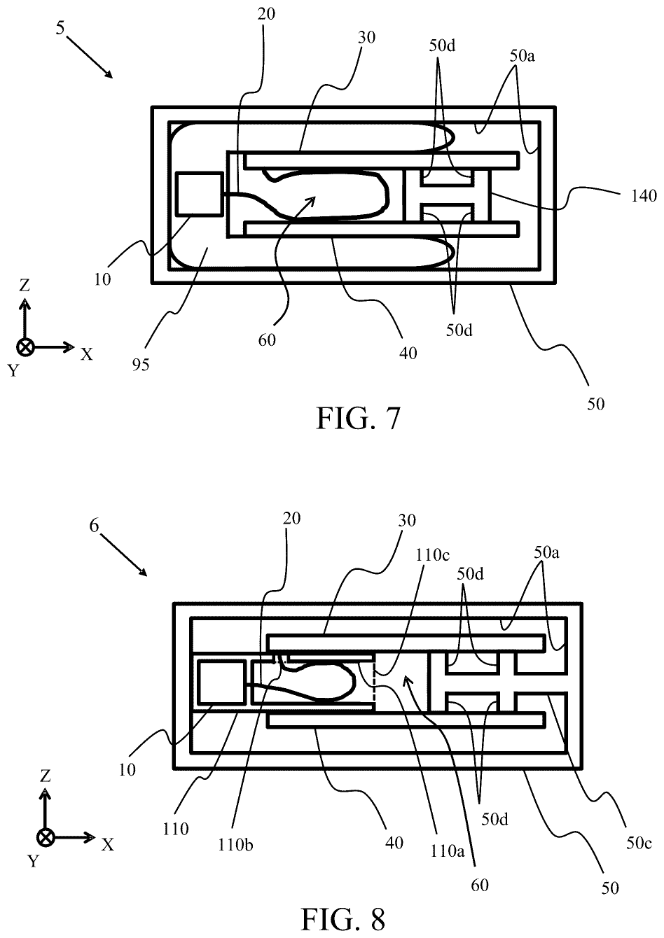

Referring now to FIG. 7, a description will be given of a microphone apparatus 5 according to Example 6. FIG. 7 is a sectional view of the microphone apparatus 5 according to this example. The microphone apparatus 5 according to this example differs from the microphone apparatus 1 according to Example 1 in that it has a fourth damper 95 and an intermediate member 140 instead of the holder 50c. A description common to Example 1 will be omitted.

The intermediate member 140 is a holding member that holds the first member 30 and the second member without contacting the housing 50. Thereby, the relative positions of the first member 30 and the second member 40 are determined. The fourth damper 95 is configured to hold the microphone element 10, the first member 30, the second member 40, and the intermediate member 140 in the housing 50. That is, the microphone element 10, the first member 30, the second member 40, and the intermediate member 140 are disposed inside the housing 50 via the fourth damper 95.

In this example, the microphone element 10, the first member 30, the second member 40, and the intermediate member 140 are disposed inside the housing 50 via the fourth damper 95, and each member is spaced apart from the inner side surface 50a of the housing 50 (without directly contacting the inner side surface 50a of the housing 50). Thus, by disposing the wiring 20 and each member in contact with the wiring 20 inside the housing 50 via a single damper (the fourth damper 95), the damper that holds each member while suppressing vibration transmitted from the housing 50 to the wiring 20 can be integrated into a single component. By integrating the internal members into a single damper, the number of components can be reduced and assembly can be improved. In this example, the fourth damper 95 is illustrated in a U-shape, but the fourth damper 95 may be configured so that each member does not come into contact with the inner side surface 50a of the housing 50, such as by covering all the internal members.

### Example 7

Referring now to FIG. 8, a description will be given of a microphone apparatus 6 according to Example 7. FIG. 8 is a sectional view of the microphone apparatus 6 according to this example. The microphone apparatus 6 according to this example differs from the microphone apparatus 1 according to Example 1 in that it has a fifth damper 110. A description common to Example 1 will be omitted.

The fifth damper 110 has a box shape 110a having space for housing the wiring 20. At least a part of the box shape 110a extends in the +X axis direction so as to be disposed inside the space 60. The box shape 110a has a through-hole 110b for electrically connecting the wiring 20 to either the first member 30 or the second member 40. The wiring 20 is housed in a bent state in the space 60 formed between the first member 30 and the second member 40 while being housed inside the box shape 110a. At this time, the wiring 20 is biased against each of the first member 30 and the second member 40 by an elastic force generated when the wiring 20 is bent. This biasing force causes the wiring 20 to contact each of the first member 30 and the second member 40 via the box shape 110a of the fifth damper 110.

In this example, a box shape 110a that houses the wiring 20 is provided in a part of the fifth damper 110, so that the wiring 20 is biased against each of the first member 30 and the second member 40 via the fifth damper 110. The fifth damper 110 that covers the microphone element 10 is expanded to form the space of the box shape 110a, and the wiring 20 contacts each of the first member 30 and the second member 40 via the fifth damper 110. Thereby, the wiring 20 can be held inside the space 60 while vibrations transmitted from the first member 30 or the second member 40 are suppressed to the wiring 20. An opening 110c is formed in the box shape 110a for bending work of the wiring 20, and the length of the wiring 20 may be adjusted through the opening 110c when it is bent or the wiring 20 may be pulled out through the through-hole 110b.

### Example 8

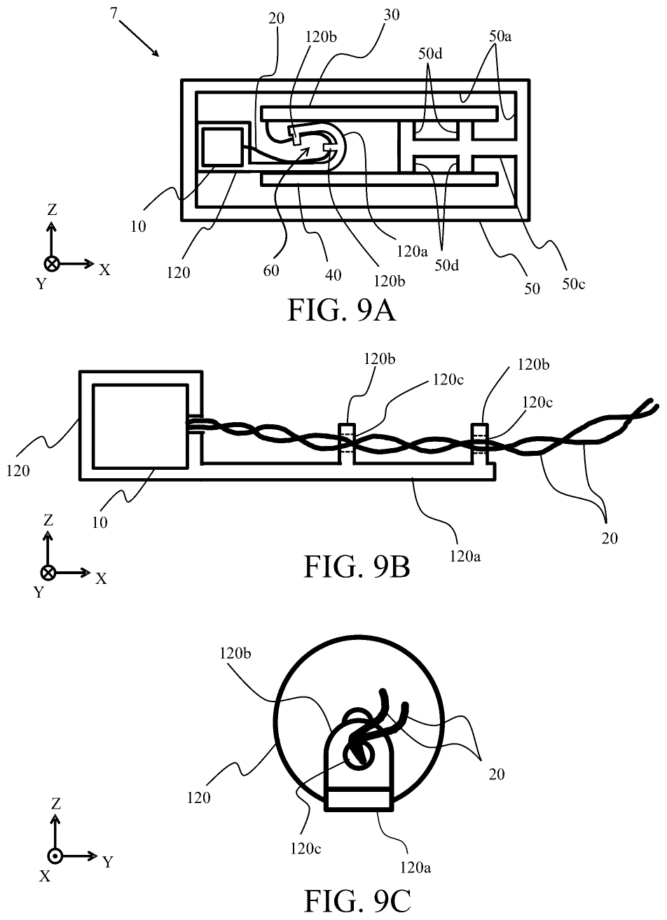

Referring now to FIGS. 9A, 9B, and 9C, a description will be given of a microphone apparatus 7 according to Example 8. FIG. 9A is a sectional view of the microphone apparatus 7 according to this example, and FIGS. 9B and 9C explain a sixth damper 120. The microphone apparatus 7 according to this example differs from the microphone apparatus 1 according to Example 1 in that it has the sixth damper 120. A description common to Example 1 will be omitted.

FIG. 9B is a detailed explanatory diagram of the sixth damper 120 covering the microphone element 10, illustrating a state before the wiring 20 is bent. FIG. 9C corresponds to FIG. 9B when viewed in the −X axis direction, illustrating a state in which the wiring 20 is housed in the sixth damper 120. The wiring 20 is illustrated in more detail in a state in which two wires are wound in a spiral shape.

In FIGS. 9B and 9C, the sixth damper 120 has a sheet-like protrusion 120a. The protrusion 120a includes a plurality of holders 120b. The holder 120b has a through-hole 120c for holding the wiring 20. While the wirings 20 pass through the through-hole 120c, the protrusion 120a and the wiring 20 extend in approximately the same direction.

Both the wirings 20 and a part of the protrusion 120a are housed in the bent state inside the space 60 formed between the first member 30 and the second member 40. At this time, the wirings 20 are biased against each of the first member 30 and the second member 40 by the elastic force generated when the wirings 20 are bent. Due to this biasing force, the wiring 20 contacts each of the first member 30 and the second member 40 via the protrusion 120a of the sixth damper 120. Thereby, the vibrations transmitted from the first member 30 or the second member 40 to the wirings 20 can be suppressed, while the shape of the damper can be simple and the wirings 20 can be incorporated at the same time. Thereby, the ease of assembly can be improved.

As described above in each example, the wirings 20 are housed in the space 60 formed by the first member 30 and the second member 40 provided inside the housing 50. However, each example is not limited to this implementation, and the housing 50 may be integrated with the first member 30 and the second member 40. In this case, the housing 50 has a double structure consisting of an external housing (first housing) and an internal housing (second housing, corresponding to the first member 30 and the second member 40) provided inside the external housing. The internal housing has space (corresponding to space 60) for storing the wiring 20, and the wiring 20 is stored in the inner space of the internal housing while the wiring 20 is electrically connected to the microphone element 10 and the internal housing. In this way, the wiring 20 does not contact the inner side surface 50a of the external housing that receives force or vibration, so the housing 50 may have a double structure.

Each example can provide a microphone apparatus that can suppress the generation of noise that is transmitted to the wiring due to the force or impact when a user grips the housing.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide a microphone apparatus capable of suppressing the generation of noise.

This application claims priority to Japanese Patent Application No. 2024-071631, which was filed on Apr. 25, 2024, and which is hereby incorporated by reference herein in its entirety.

What is claimed is:

1. A microphone apparatus comprising:
a microphone element;
a wiring;
a first member;
a second member;
a holder; and
a housing,
wherein the microphone element, the wiring, the first member, the second member, and the holder are disposed inside the housing,
wherein the holder holds at least one of the first member and the second member,
wherein the wiring electrically connects the microphone element to at least one of the first member and the second member, and
wherein at least a part of the wiring is housed in space formed by the holder, the first member, and the second member.

2. The microphone apparatus according to claim 1, wherein the wiring, the first member, and the second member are spaced from an inner side surface of the housing.

3. The microphone apparatus according to claim 1, wherein the holder is a rib extending vertically from an inner side surface of the housing, and is connected to each of the first member and the second member via a first connector provided to the rib, and
wherein the first connector is provided in an area of the holder that is farthest from a second connector to the inner side surface of the housing.

4. The microphone apparatus according to claim 1, wherein the holder is a rib extending vertically from an inner side surface of the housing, and is connected to each of the first member and the second member via a first connector provided on the rib, and
wherein the first connector is provided in an area near a corner of the housing.

5. The microphone apparatus according to claim 1, further comprising a first damper covering the microphone element,
wherein the microphone element is held in the housing via the first damper.

6. The microphone apparatus according to claim 1, further comprising a second damper,
wherein the holder holds at least one of the first member and the second member via the second damper.

7. The microphone apparatus according to claim 1, wherein the holder holds the first member and the second member such that a main surface of the first member and a main surface of the second member are perpendicular to a thickness direction of the housing, and thereby positions of the first member and the second member in the thickness direction are determined.

8. The microphone apparatus according to claim 1, wherein the holder holds the first member and the second member such that a main surface of the first member and a main surface of the second member are perpendicular to a thickness direction of the housing, and
wherein the space is a part of an internal space of the housing that includes a center of the housing in the thickness direction.

9. The microphone apparatus according to claim 8, wherein a length of the space in the thickness direction is 75% or less of a length of the internal space.

10. The microphone apparatus according to claim 1, further comprising a third damper provided to an inner side surface of the housing,
wherein the wiring contacts the third damper.

11. The microphone apparatus according to claim 1, wherein at least a part of the wiring is housed in the space in a bent state.

12. The microphone apparatus according to claim 1, wherein at least one of the first member and the second member has a rigidity higher than a rigidity of the housing.

13. The microphone apparatus according to claim 1, further comprising a fifth damper having a box shape and covering the microphone element,
wherein a part of the wiring is housed in the fifth damper, and
wherein at least part of the fifth damper is disposed in the space.

14. The microphone apparatus according to claim 1, further comprising a sixth damper covering the microphone element,
wherein the sixth damper has a protrusion having a sheet shape, and
wherein at least part of the protrusion and the wiring are disposed in a bent state inside the space.

15. The microphone apparatus according to claim 1, further comprising a fixing member configured to fix the wiring to at least one of the first member and the second member.

16. A microphone apparatus comprising:
a microphone element;
a wiring; and
a housing,
wherein the housing includes a first housing and a second housing disposed inside the first housing,
wherein the wiring electrically connects the microphone element and the second housing, and
wherein at least a part of the wiring is housed in space formed by the second housing.
